(19) United States
(12) Patent Application Publication
(10) Pub. No.: US 2013/0143725 A1
(43) Pub. Date: Jun. 6, 2013

(54) ROLLER AND METHOD FOR MAKING SAME

(71) Applicant: CHIA-LING HSU, Tu-Cheng (TW)

(72) Inventor: CHIA-LING HSU, Tu-Cheng (TW)

(73) Assignee: HON HAI PRECISION INDUSTRY CO., LTD., Tu-Cheng (TW)

(21) Appl. No.: 13/488,561

(22) Filed: Jun. 5, 2012

(30) Foreign Application Priority Data
Dec. 6, 2011 (TW) 100144765

(51) Int. Cl. F16C 13/00; B05D 3/12; B05B 1/24; B05D 3/06

(52) U.S. Cl. 492/53; 427/554; 427/355; 118/620; 118/102

(57) ABSTRACT

A roller includes a cylindrical main body, a resin coating formed on a peripheral side surface of the main body, and a plurality of micro recesses defined in the resin coating. The resin coating is a polymer resin coating having the molecular chain with fluorine element. A method for making the roller and a system for making the roller are also provided.

### BACKGROUND

1. Technical Field

The present disclosure generally relates to a roller applied in making a light guide plate, and a method for making the roller.

2. Description of Related Art

A light guide plate may include a light emitting surface, a light reflection surface opposite to the light emitting surface, and a plurality of nodes or micro structures formed on the light reflection surface of the optical plate. The plurality of nodes or micro structures are configured for breaking up a total reflection condition of the light beam, and ensuring that most of the light beams can pass through the light emitting surface of the light guide plate thereby improving the uniformity and brightness of the light guide plate. One method for forming the nodes or micro structures is a roll forming process by using a metal roller. However, the roller of the roll forming process has a relatively low forming efficiency, and has a relatively high cost.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 shows a cross-sectional view of an embodiment of a roller.

FIG. 2 shows a view of a first embodiment of a method for making the roller.

FIG. 3 shows a flowchart of the first embodiment of method for making the roller.

FIG. 4 shows a view of a second embodiment of the method for making the roller.

FIG. 5 shows a flowchart of the second embodiment of method for making the roller.

### DETAILED DESCRIPTION

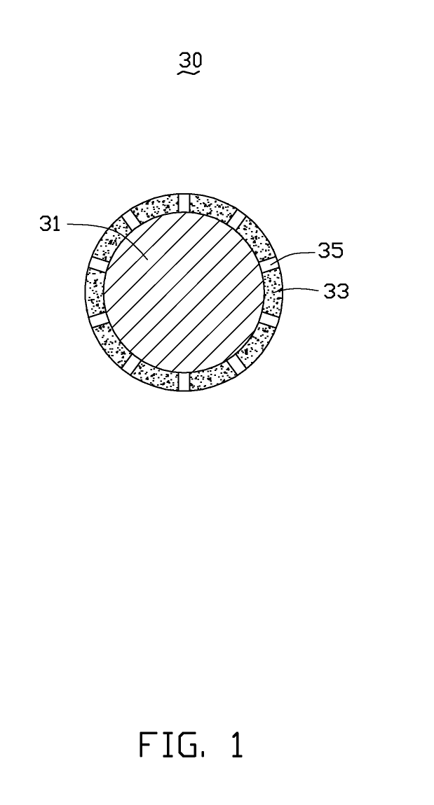

Referring to FIG. 1, a schematic cross-sectional view of an embodiment of a roller 30 is shown. The roller 30 is for making a light guide plate, and includes a cylindrical main body 31, and a resin coating formed on a peripheral side surface (not labeled) of the cylindrical main body 31. The roller 30 defines a plurality of micro recesses 35 in a resin coating 33. In the illustrated embodiment, the cylindrical main body 31 is a cylindrical body made of stainless steel. The resin coating 33 is a polymer resin coating having the molecular chain with fluorine element. In one embodiment, the resin coating 33 is made of ethylene-tetrafluoroethylene copolymer.

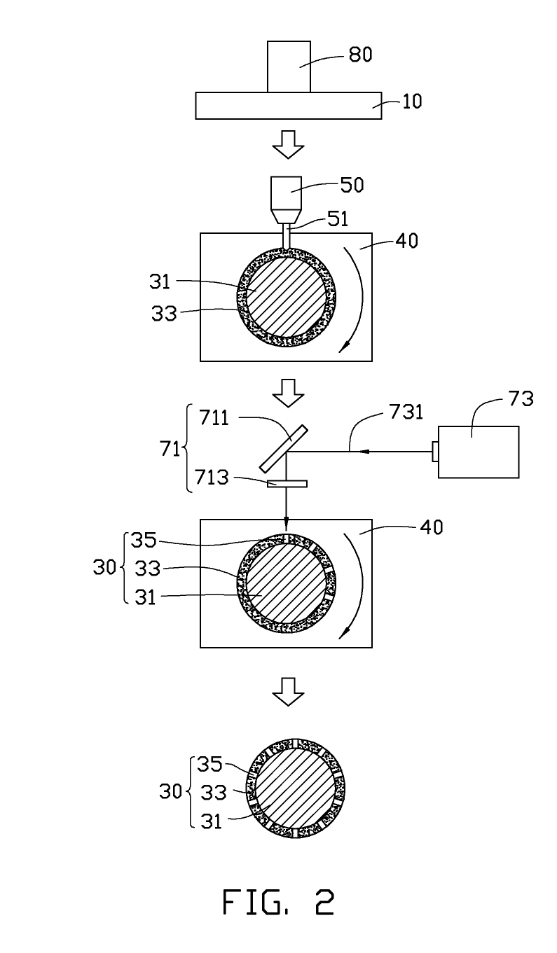

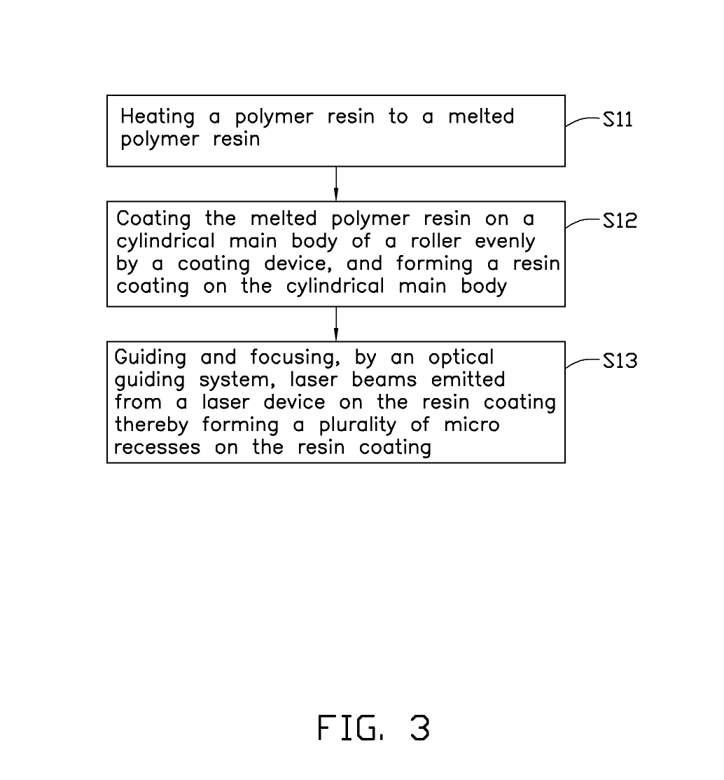

Also referring to FIGS. 2 and 3, a method of a first embodiment for making the roller 30 is illustrated as follows.

In step S11: a heating apparatus 10 and a polymer resin 80 are provided, the polymer resin 80 is melted by the heating apparatus 10. In the illustrated embodiment, the polymer resin 80 is made of ethylene-tetrafluoroethylene copolymer. The polymer resin 80 is placed on the heating apparatus 10 and melted. After that, the melted polymer resin 80 is kept at a constant temperature. The melted temperature of the polymer resin 80 is about 250 degrees Celsius.

In step S12: a coating device 50 and the cylindrical main body 31 are provided, the melted polymer resin 80 is evenly coated on the peripheral side surface of the cylinder main body 31 by the coating device 50, to form the resin coating 33. In the illustrated embodiment, the cylindrical main body 31 is made of stainless steel. The resin coating 33 is formed by the following steps: firstly, the cylindrical main body 31 and a shifting apparatus 40 are provided, the shifting apparatus 40 is positioned opposite to the coating device 50; the cylindrical main body 31 is mounted on the shifting apparatus 40. The coating device 50 includes a spraying nozzle 51 aligning with the peripheral side surface of the cylindrical main body 31. The melted polymer resin 80 is poured into the coating device 50 and is sprayed so as to coat the peripheral side surface of the cylindrical main body 31 by the spraying nozzle 51; meanwhile, the shifting apparatus 40 drives the cylindrical main body 31 to rotate thereby enable the melted polymer resin 80 to be sprayed evenly on the main body 31.

In step S13: an optical guiding system 71 and a laser device 73 are provided for forming the plurality of micro recesses 35 on the resin coating 33. The laser device 73 emits laser beams 731. The laser beams 731 are guided and reflected onto the resin coating 33 by the optical guiding system 71 to form the micro recesses 35 on the resin coating 33. In the illustrated embodiment, the optical guiding system 71 includes a reflector 711 and a focusing lens 713. The focusing lens 713 aligns with the resin coating 33. The laser beams 731 emitted by the laser device 73 are firstly transmitted to the reflector 711, and then reflected to the focusing lens 713, and finally reach the resin coating 33 of the main body 31 to form the micro recesses 35. The shifting apparatus 40 drives the main body 31 together with the resin coating 33 to rotate, thereby forming the micro recesses 35 on the whole resin coating 33, to achieve the roller 30.

In one embodiment, a cooling step is added before the step S03.

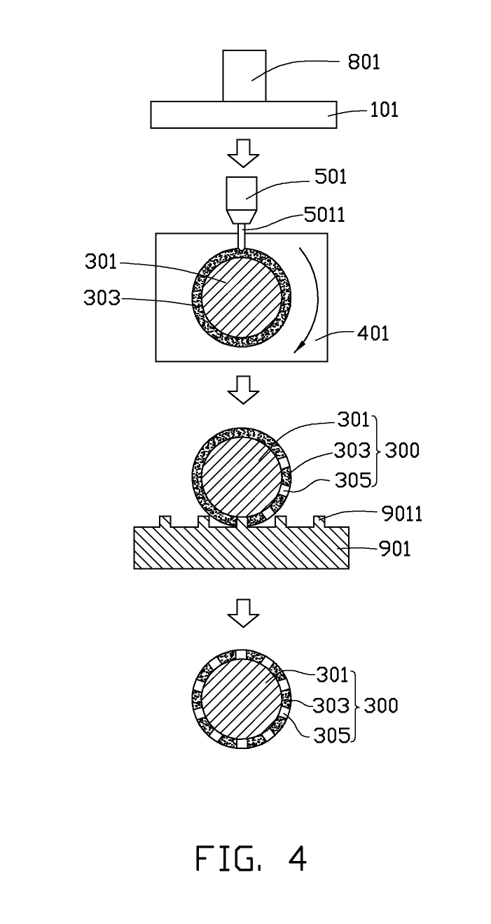

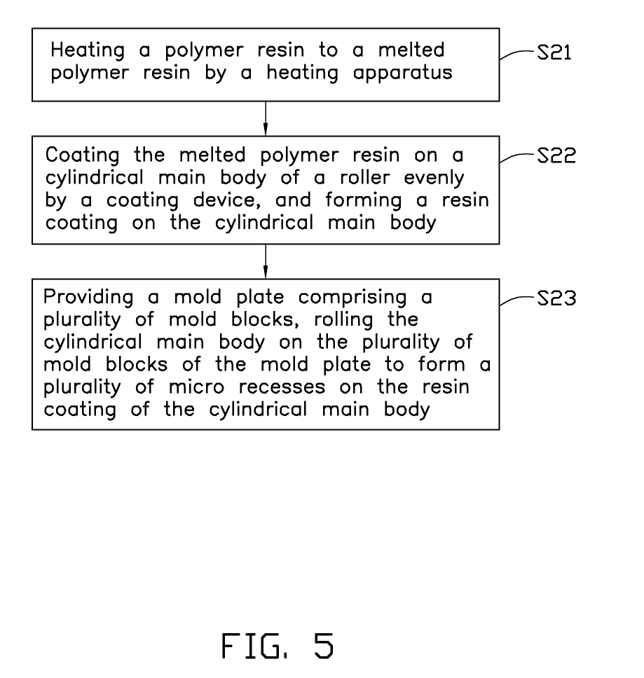

Also referring to FIGS. 4 and 5, a method of a second embodiment for making the roller 30 is illustrated as follows.

In step S21: a heating apparatus 101 and a polymer resin 801 are provided, the polymer resin 801 is melted by the heating apparatus 101. In the illustrated embodiment, the polymer resin 801 is made of ethylene-tetrafluoroethylene copolymer. The polymer resin 801 is placed on the heating apparatus 101 and melted. After that, the melted polymer resin 801 is kept at a constant temperature. The melted temperature of the polymer resin 801 is about 250 degrees Celsius.

In step 22: a coating device 501 and the cylindrical main body 31 are provided, the melted polymer resin 801 is evenly coated on the peripheral side surface of the cylindrical main body 301 by the coating device 501, to form a resin coating 303. In the illustrated embodiment, the cylindrical main body 301 is made of stainless steel. The resin coating 303 is formed by the following steps: firstly, the cylindrical main body 301 and a shifting apparatus 401 are provided, the shifting apparatus 401 is positioned opposite to the coating device 501; the cylindrical main body 301 is mounted on the shifting apparatus 401. The coating device 501 includes a spraying nozzle 5011 aligning with the peripheral side surface of the cylindrical main body 301. The melted polymer resin 801 is poured into the coating device 501 and is sprayed so as to coat the peripheral side surface of the cylindrical main body 301 by the spraying nozzle 5011; meanwhile, the shifting apparatus 401 drives the cylindrical main body 301 to rotate thereby ensuring an even spray and coating on the cylindrical main body 301.

In step S23: a mold plate 901 with a plurality of mold blocks 9011 formed on a top mold surface (not labeled) of the mold plate 901 is provided, for forming a plurality of micro recesses 305 on the resin coating 303. The main cylindrical body 301 together with the resin coating 303 is placed on the mold plate 901, and is rolled on the mold blocks 9011 of the mold plate 901 to form the plurality of micro recesses 305. In the illustrated embodiment, the mold plate 901 is substantially rectangular, and the mold blocks 9011 are formed by an etching process or a laser process.

In one embodiment, the micro recesses 305 are formed by the following steps: firstly, the resin coating 303 for the cylindrical main body 301 is heated to a half-melted state by the heating apparatus 101; and then, the cylindrical main body 301 together with the resin coating 303 is placed on the mold plate 901 and rolled on the mold blocks 9011 of the mold plate 901 to form the plurality of micro recesses 305; finally, the rolled cylindrical main body 301 is cooled down to achieve the roller 300.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A roller comprising:
a cylindrical main body;
a resin coating formed on a peripheral side surface of the cylindrical main body; and
a plurality of micro recesses defined in the resin coating,
wherein the resin coating is a polymer resin coating comprising the molecular chains with fluorine elements.

2. The roller of claim 1, wherein the cylindrical main body is cylindrical shaped and made of stainless steel.

3. The roller of claim 1, wherein the resin coating is made of ethylene-tetrafluoroethylene copolymer.

4. A roller making method, comprising:
heating a polymer resin to a melted polymer resin;
coating the melted polymer resin on a cylindrical main body of a roller evenly by a coating device, and forming a resin coating on the cylindrical main body, the cylindrical main body comprising molecular chains with fluorine elements;
guiding and focusing, by an optical guiding system, laser beams emitted from a laser device on the resin coating; and
forming a plurality of micro recesses on the resin coating.

5. The roller making method of claim 4, wherein the cylindrical main body is a metal cylinder made of stainless steel.

6. The roller making method of claim 4, wherein the polymer resin is made of ethylene-tetrafluoroethylene copolymer.

7. The roller making method of claim 6, the step of coating further comprising rotating the cylindrical main body by a shifting apparatus, spraying the melted polymer resin, and coating a peripheral side surface of the cylindrical main body with the melted polymer resin.

8. The roller making method of claim 7, further comprising pouring the melted polymer resin into the coating device, and spraying the melted polymer resin by a spraying nozzle aligned with the peripheral side surface of the main cylindrical body.

9. The roller making method of claim 7, wherein the optical guiding system comprises a reflector and a focusing lens; the step of guiding and focusing comprises aligning the focusing lens with the resin coating, transmitting the laser beams to the reflector, and reflecting the laser beams to the focusing lens thereby focusing the laser beams on the resin coating to form the plurality of micro recesses.

10. The roller making method of claim 9, further comprising cooling the resin coating before the step of forming the plurality of micro recesses.

11. A roller making method, comprising:
heating a polymer resin to a melted polymer resin by a heating apparatus;
coating the melted polymer resin on a cylindrical main body of a roller evenly by a coating device, and forming a resin coating on the cylindrical main body, the cylindrical main body comprising molecular chains with fluorine elements;
providing a mold plate comprising a plurality of mold blocks;
rolling the cylindrical main body on the plurality of mold blocks of the mold plate; and
forming a plurality of micro recesses on the resin coating of the cylindrical main body.

12. The roller making method of claim 11, wherein the mold plate is substantially rectangular, and step of forming the plurality of mold blocks is carried out by etching processes or laser processes.

13. A system for making a roller, the roller comprising a cylindrical main body, a resin coating formed on a peripheral side surface of the cylindrical main body, and a plurality of micro-recesses defined in the resin coating; the system comprising:
a heating apparatus for melting a polymer resin;
a coating device for forming the resin coating on the cylindrical main body, the coating device comprising a spraying nozzle aligning with the cylindrical main body;
a shifting apparatus positioned opposite to the coating device for driving the cylindrical main body to rotate thereby enabling the melted polymer resin to be sprayed evenly on the cylindrical main body;
a laser device for emitting laser beams; and
an optical guiding system guiding and reflecting the laser beams onto the resin coating for forming the plurality of micro recesses on the resin coating.

14. The system of claim 13, wherein the optical guiding system comprises a reflector and a focusing lens, the focusing lens aligns with the resin coating, the laser beams emitted by the laser device are firstly transmitted to the reflector, and then reflected to the focusing lens, and finally reach the resin coating of the main body 31 to form the micro recesses.

15. A roller making system comprising:
a heating apparatus adapted to melt a polymer resin;
a coating device adapted to coat a resin coating on a cylindrical main body of a roller with a molten polymer resin from the heating apparatus, the coating device comprising a spraying nozzle aligned with the cylindrical main body;
a shifting apparatus positioned opposite to the coating device, the shifting apparatus being adapted to rotate the cylindrical main body when the coating device is coating the resin coating on the cylindrical main body;
a mold plate comprising a plurality of mold blocks, the mold plate being adapted to roll the resin coating and to form a plurality of micro recesses on the resin coating.
